(19) United States
(12) Patent Application Publication
(10) Pub. No.: US 2025/0135961 A1
(43) Pub. Date: May 1, 2025

(54) SEAT ELEMENT AND MOTOR VEHICLE SEAT

(71) Applicant: FAURECIA Sièges d'Automobile, NANTERRE (FR)

(72) Inventors: Sascha HEIDEN, HANNOVER (DE); Mamadou BALDE, MORIGNY-CHAMPIGNY (FR); Axel DEVAILLY, AUBIGNY SUR NÈRE (FR)

(21) Appl. No.: 18/931,711

(22) Filed: Oct. 30, 2024

(30) Foreign Application Priority Data
Oct. 31, 2023 (FR) 2311861

(51) Int. Cl. B60N 2/00; B60N 2/60

(52) U.S. Cl. CPC B60N 2/0021; B60N 2/60

(57) ABSTRACT

The present disclosure relates to a seat element comprising a padding and a cover arranged around the padding, the seat element comprising two longitudinal side edges, a first side of the seat element being located on one side of a longitudinal central plane, a second side being located on the other side of the longitudinal central plane, the seat element comprising a first coplanar interdigital electrode capacitive sensor arranged on the first side and a second coplanar interdigital electrode capacitive sensor arranged on the second side, the second capacitive sensor being distant from the first capacitive sensor in a longitudinal direction by a first distance of between 30 millimeters and 50 millimeters.

### PRIORITY CLAIM

This application claims priority French Patent Application No. FR2311861, filed Oct. 31, 2023, which is expressly incorporated by reference herein.

### BACKGROUND

The present disclosure relates to a seat element and a seat comprising this seat element. In particular, the present disclosure relates to a removable seat cushion that can be attached to and rested on a back rest or seat squab.

### SUMMARY

According to the present disclosure, a seat element of a seat, in particular of a motor vehicle seat; the seat element comprising a padding and a cover arranged around the padding, the seat element extending in a transverse direction and a longitudinal direction; the seat element comprising two longitudinal side edges; a longitudinal central plane extending between and halfway between the two longitudinal side edges; a first side of the seat element being located on one side of the longitudinal central plane, a second side being located on the other side of the longitudinal central plane; the seat element comprising a first coplanar interdigital electrode capacitive sensor arranged on the first side and a second coplanar interdigital electrode capacitive sensor arranged on the second side; the second capacitive sensor being distant from the first capacitive sensor in a longitudinal direction by a first distance of between 30 millimeters and 50 millimeters, and preferably by a first distance of 40 millimeters.

Advantageously, when the second and third capacitive sensors are separated by this first distance, the capacitance values they generate enable body torsion positions to be detected, whatever the size of the seat and the morphology of the occupant.

The features disclosed in the following paragraphs may optionally be implemented. They can be implemented independently of one another or in combination with one another:
The seat element comprises a removable back rest cushion intended to be placed on a seat, the seat comprising a squab and a back rest articulated to the squab, the back rest having a front face suitable for receiving a back of an occupant, the removable back rest cushion being intended to be placed on the front face of the back rest of the seat.
The first capacitive sensor is spaced apart from the second capacitive sensor by a second distance of between 50 millimeters and 150 millimeters, preferably by a second distance of 80 millimeters, this second distance being measured in a transverse direction.
It further comprises a third coplanar interdigital electrode capacitive sensor arranged on the first side of the central longitudinal plane, and the third capacitive sensor is distanced from the first capacitive sensor in the longitudinal direction by a third distance of between 250 millimeters and 290 millimeters, and preferably by a third distance equal to 270 millimeters.

Advantageously, when the first and third capacitive sensors are separated by this distance, the capacitance values generated by these sensors can detect rounding of the seat occupant's back around a horizontal axis, whatever the size of the seat and the morphology of the seat occupant.
It further comprises a fourth coplanar interdigital electrode capacitive sensor arranged on the second side of the central longitudinal plane, the fourth capacitive sensor being distanced from the third capacitive sensor in the longitudinal direction by a fourth distance of between 30 millimeters and 50 millimeters, and preferably by a fourth distance equal to 40 millimeters.
The fourth capacitive sensor is spaced apart from the third capacitive sensor by a fifth distance of between 50 millimeters and 150 millimeters, and preferably by a fifth distance of 80 millimeters, the fifth distance being measured in a transverse direction.

The removable seat cushion is intended to be mounted on a seat comprising a headrest and at least one rod attached to the back rest and the headrest, and wherein the seat cushion comprises at least one opening for receiving the at least one headrest attachment rod, the seat cushion having a front edge bordering the opening and extending over the front face of the seat back rest, and the first capacitive sensor is located at a sixth distance from the front edge; the sixth distance being between 200 and 300 millimeters, and preferably the sixth distance being equal to 250 millimeters.

Advantageously, this positioning of the first capacitive sensor makes it possible to detect a more pronounced movement or pressure of the shoulder blade of a seat occupant.
The removable seat cushion is intended to be mounted on the back rest comprising an upper face, and wherein the removable seat cushion comprises a bearing portion intended to bear against the upper face of the back rest, the bearing portion comprising a front end intended to be arranged between the upper face and the front face of the back rest, and wherein the first capacitive sensor is located at a sixth distance from the front end of the bearing portion, the sixth distance being between 200 and 220 millimeters, and preferably the sixth distance being equal to 210 millimeters.
The seat element comprises a removable seat squab cushion intended to be placed on a seat, the seat comprising a squab and a back rest articulated to the squab, the squab having a squab face suitable for receiving an occupant, the removable squab cushion being intended to be placed on the squab face of the squab of the seat.
The seat element comprises a third coplanar interdigital electrode capacitive sensor arranged on the first side and a fourth coplanar interdigital electrode capacitive sensor arranged on the second side, the third capacitive sensor being separated from the fourth capacitive sensor in a longitudinal direction by a fourth distance of between 30 millimeters and 50 millimeters and, preferably, by a fourth distance D4′ equal to 40 millimeters.

The present disclosure also relates to a seat, in particular a motor vehicle seat, the seat comprising a squab and a back rest articulated to the squab, the back rest having a front face, a rear face and an upper face, the seat comprising a seat element having at least one of the above-mentioned characteristics, and the first capacitive sensor is located at a sixth distance of between 200 and 300 millimeters, and preferably at a sixth distance of 250 millimeters from the edge located between the upper face and the front face, when the seat element is attached to the seat.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a perspective view of a seat whereupon a seat element according to a first embodiment rests;

FIG. 2 is a schematic sectional view of a seat element according to the first embodiment, the section being taken in a median plane of the seat element;

FIG. 3 is a schematic front view of an example of a capacitive sensor to be arranged in the seat element according to the present disclosure;

FIG. 4 is a schematic cross-sectional view of a first variant of the seat element according to the first embodiment;

FIG. 5 is a perspective view of a seat whereupon a second variant of the seat element according to the first embodiment rests; and

FIG. 6 is a top view of a seat fitted with a seat element according to a second embodiment of the present disclosure.

### DETAILED DESCRIPTION

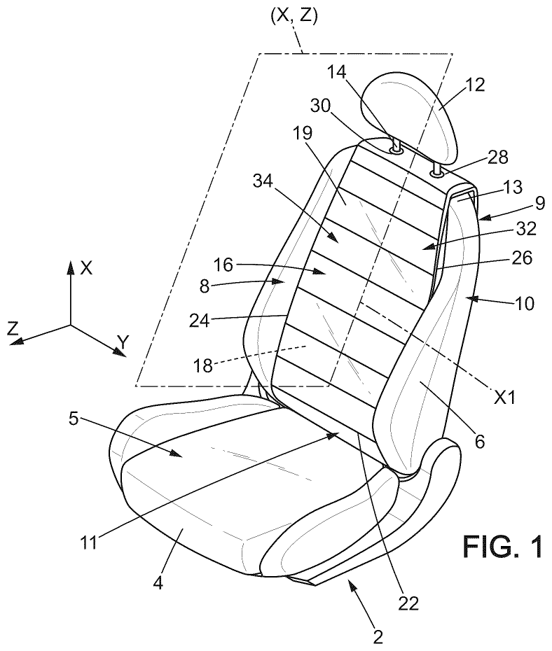

In the following description, spatial positioning indications such as front, rear, top, bottom, upper, lower, horizontal, vertical, etc. are to be interpreted according to the usual position of use of a seat in a vehicle as well as the usual position of a removable cushion arranged on the seat. The front direction is the direction of a vehicle traveling forward. These common positions are shown in FIG. 1. In particular, the front face of a back rest is the face whereupon the back of a seat occupant rests.

FIG. 1 shows an example of a seat 2 according to the present disclosure. The seat 2 comprises a squab 4, a back rest 6 articulated to the squab and a headrest 12 attached to the back rest by rods 14.

The squab 4 has a squab face 5 configured to accommodate the buttocks and part of the legs of a seat occupant.

The back rest 6 further comprises a front face 8, a rear face 9, two side faces 10, a lower face 11 articulated to the squab and an upper face 13 opposite the lower face.

A seat element according to a first embodiment of the disclosure is a removable back rest cushion 16, that is, the removable cushion is intended to be placed on the front face 8 of the seat back rest. This removable cushion 16 comprises at least one padding 18 and a cover 19 arranged around the padding. The padding 18 comprises a layer of foam or stuffing. The padding may also comprise several layers of foam or stuffing.

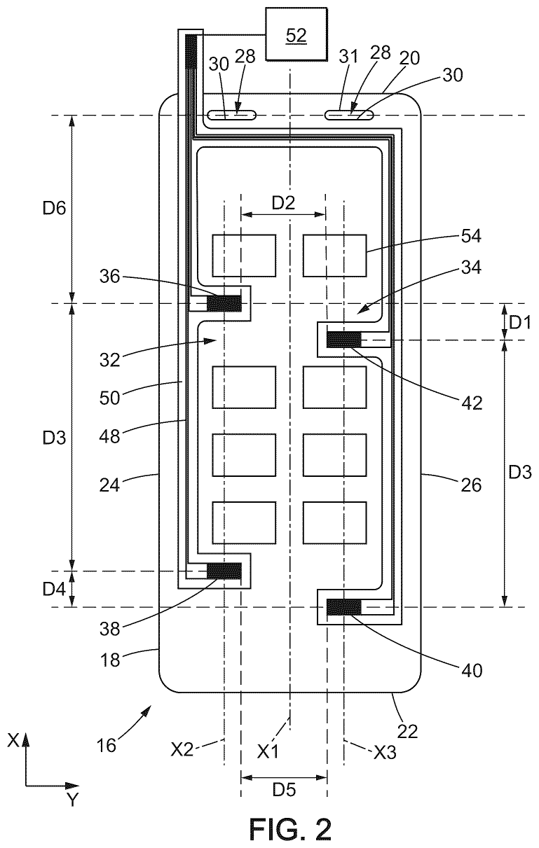

Referring to FIG. 2, the removable cushion 16 extends in a longitudinal direction X and a transverse direction Y perpendicular to the longitudinal direction X. The removable cushion 16 has an upper transverse edge 20 and a lower transverse edge 22 extending in the transverse direction Y. The removable cushion 16 further comprises two longitudinal side edges 24, 26 extending in the longitudinal direction X.

In the embodiment shown in FIGS. 1 and 2, the removable cushion 16 further comprises two openings 28 or indentations to receive the headrest rods 14. The openings have a front edge 30 on the front side 8 of the back rest and a rear edge 31 on the rear side 9 of the back rest, when the removable cushion 16 is mounted on the seat back rest.

For the purposes of this description, a central longitudinal plane (X,Z) is defined, perpendicular to the median plane of the cushion. It intersects the center of the removable cushion along a central straight line X1. The central straight line X1 runs parallel to the longitudinal side edges 24, 26. The central straight line X1 is located in the center, that is, halfway between the two longitudinal side edges 24, 26. For the purposes of this description, the “first side 32” of the cushion is the side of the cushion located on one side of the central longitudinal plane (X,Z), for example on the left, and the “second side 34” is the side of the cushion located on the other side of the central longitudinal plane, for example on the right.

FIG. 2 schematically shows an example of a cross-sectional view of the removable cushion 16 according to a first embodiment of the disclosure.

The removable cushion 16 comprises a first coplanar interdigital electrode capacitive sensor 36 and a second coplanar interdigital electrode capacitive sensor 42, hereinafter referred to as the first and second capacitive sensors.

The first capacitive sensor 36 and the second capacitive sensor 42 are arranged between the cover 19 and the padding when the padding has a foam layer. Alternatively, the first capacitive sensor 36 and the second capacitive sensor 42 are arranged between two foam layers when the padding has two foam layers. The first capacitive sensor and the second capacitive sensor extend in the transverse direction Y. They are suitable for measuring capacitance values.

The first capacitive sensor 36 is located on the first side 32 of the central longitudinal plane (X, Z). The second capacitive sensor 42 is located on the second side 34 of the central longitudinal plane (X, Z).

The first capacitive sensor 36 is separated from the second capacitive sensor 42 in a longitudinal direction X by a first distance D1 of between 30 and 50 millimeters. Preferably, the first distance D1 is equal to 40 millimeters. In the embodiment shown, the first capacitive sensor 36 is closer to the upper transverse edge 20 of the cushion than the second capacitive sensor 42.

Advantageously, when the first and second capacitive sensors are separated by this first distance D1, the capacitance values they generate enable body torsion positions to be detected, whatever the size of the seat and the morphology of the occupant. The term “torsion position” refers to the pivoting of the body about a vertical axis at the spine, and any resulting malpositioning of the pelvis. Such torsion may, for example, result from a driver holding the steering wheel with one hand, or a person sitting in an office chair crossing one leg over the other. The offset between the positioning of the first capacitive sensor and the positioning of the second capacitive sensor enables highly effective detection of poor posture, when the removable cushion is arranged on seat back rests of different sizes and for people with different morphologies.

Preferably, the first capacitive sensor 36 is separated from the second capacitive sensor 42 by a second distance D2 in the transverse direction Y. The second distance is between 50 and 150 millimeters. Preferably, the second distance is equal to 80 millimeters.

The ends of the capacitive sensors on the side facing the center of the seat cushion are used to take measurements in the longitudinal direction Y, as shown in FIG. 2.

Preferably, the seat cushion further comprises a third coplanar interdigital electrode capacitive sensor 38 arranged between the cover 19 and the padding or between two foam layers of the padding. The third capacitive sensor 38 is located on the first side 34 of the central longitudinal plane (X, Z).

Preferably, the first capacitive sensor 36 and the third capacitive sensor 38 are aligned with one another along a first straight line X2 running in the longitudinal direction X.

Preferably, the third capacitive sensor 38 is separated from the first capacitive sensor 36 in the longitudinal direction X by a third distance D3. The third distance D3 is between 250 and 290 millimeters. Preferably, the third distance D3 is equal to 270 millimeters. The middle of the capacitive sensors is used to perform distance measurements along the longitudinal direction X in the present application as seen in FIG. 2.

When the first and third capacitive sensors are separated by this distance, the capacitance values generated by these sensors can detect rounding of the seat occupant's back around a horizontal axis, whatever the size of the seat and the morphology of the seat occupant. Morphology refers to the general shape of people. It includes the height and width of a person.

Advantageously, this positioning of the third capacitive sensor 38 makes it possible to detect a more pronounced movement or pressure of part of the pelvis of a seat occupant.

Preferably, the removable cushion 16 further comprises a fourth coplanar interdigital electrode capacitive sensor 40 arranged between the cover 19 and the padding or between two foam layers of the padding. The fourth capacitive sensor 40 is located on the second side 34 of the central longitudinal plane (X, Z).

Preferably, the fourth capacitive sensor 40 is separated from the third capacitive sensor 38 in a longitudinal direction X by a fourth distance D4 of between 30 millimeters and 50 millimeters. Preferably, the fourth distance D4 is equal to 40 millimeters. In the embodiment shown in FIG. 2 by way of example, the fourth capacitive sensor 40 is closer to the lower transverse edge 22 of the cushion than the third capacitive sensor 38.

Preferably, the fourth capacitive sensor 40 and the second capacitive sensor 42 are aligned along a straight line X3 extending in a longitudinal direction X. Preferably, the fourth capacitive sensor 40 is spaced apart from the second capacitive sensor 42, along a longitudinal direction X, by the third distance D3.

Preferably, the fourth capacitive sensor 40 is separated from the third capacitive sensor 38 by a fifth distance D5 in the transverse direction Y. The fifth distance is between 50 millimeters and 150 millimeters. Preferably, the fifth distance is equal to 80 millimeters.

Also preferably, the fifth distance D5 is equal to the second distance D2.

In the embodiment shown, the first capacitive sensor 36 is closer to the upper transverse edge 20 than the second capacitive sensor 42. The first capacitive sensor 36 is located at a sixth distance D6 of between 200 and 300 millimeters from the front edge 30 of the cushion opening 28. Preferably, the sixth distance D6 is equal to 250 millimeters. This positioning of the first capacitive sensor 36 makes it possible to detect a more pronounced movement or pressure of the shoulder blade of a seat occupant.

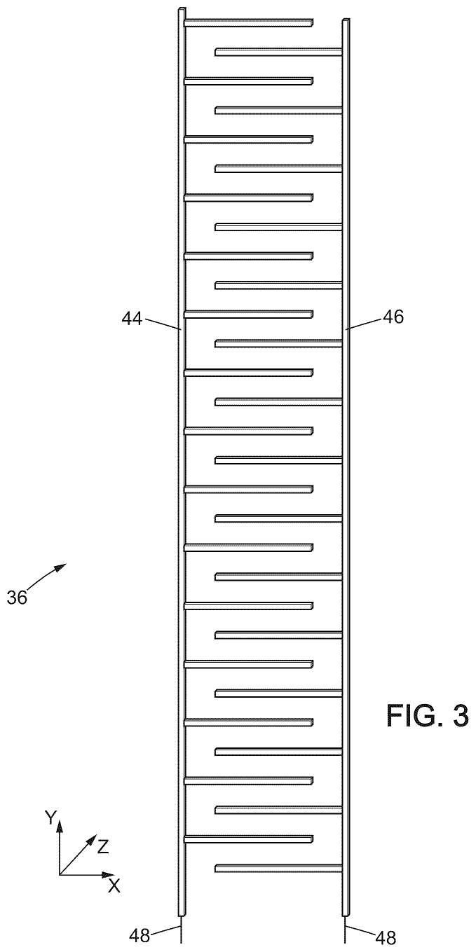

Preferably, all four capacitive sensors are identical. An example of the first capacitive sensor 36 able to be arranged in the removable cushion 16 is shown in FIG. 3.

The first capacitive sensor 36 comprises a first electrode 44 and a second electrode 46 similar to the first electrode. Each electrode comprises a rod and fingers attached to the rod. The fingers extend perpendicular to the rod. The fingers are spaced apart in a comb-like configuration. The second electrode is positioned relative to the first electrode such that the fingers of the second electrode are interposed between the fingers of the first electrode. An example of the dimensions of the rods, fingers and spacing between the rods and fingers of a capacitive sensor that can be arranged in the removable cushion is disclosed in the patent application published under number FR 3 126 776.

The first electrode 44 is connected to a voltage source via an electrical connection wire 48. The voltage source generates a voltage of 5 volts, for example. The second electrode 46 is connected to a ground via an electrical connection wire 48.

The first capacitive sensor 36, the second capacitive sensor 42, the third capacitive sensor 38, the fourth capacitive sensor 40 and the electrical connection wires 48 are arranged on a flexible support 50. The flexible support 50 is attached against a layer of foam or stuffing.

The removable cushion 16 may comprise a controller 52. The controller 52 can be placed in a bag formed at one end of the cushion. The first and second electrodes of the capacitive sensors 36, 38, 40, 42 are connected to the controller 52 via the electrical connection wires 48.

The controller is configured to periodically receive capacitance values from the capacitive sensors. The controller is configured to detect a rotation of a body part, in particular a part of the torso, of a seat occupant leaning against the seat cushion from the received capacitance values.

The controller 52 can be a device which is programmable using software or a specific integrated circuit (ASIC). The controller comprises a memory and executable code for implementing a method for detecting rotation of a part of the torso of a seat occupant from capacitance values received from the capacitive sensors previously disclosed. The memory comprises a random access memory, denoted RAM, and a read-only memory, denoted ROM. The memory can comprise executable code to implement a method of detecting rotation of a portion of the torso of a seat occupant as disclosed in the patent application published on Aug. 26, 2022 in the name of the applicant under number FR3120124, which is incorporated by reference herein in its entirety, as well as several ranges of variation of capacitance values as disclosed in this patent application. Capacitance value variation ranges can be preset during a learning phase.

The removable cushion 16 can comprise comfort equipment 54 arranged in the cushion between the cover 19 and a foam layer or between two foam layers of the padding. Comfort equipment 54 comprises, for example, vibrating equipment or pneumatic equipment to perform a massage function, a ventilation actuator and heating equipment.

Comfort equipment 54 is connected to the controller 52. The controller 52 controls the operation of the comfort equipment on command from the seat occupant or when it detects incorrect positioning of the seat occupant.

Eight comfort equipment items 54 are shown in FIG. 2. Alternatively, the removable cushion comprises a different number of comfort features.

Alternatively, the removable cushion 16 does not comprise a controller. The electrical connection wires 48 are connected to a connector intended for connection to a seat electrical cable harness.

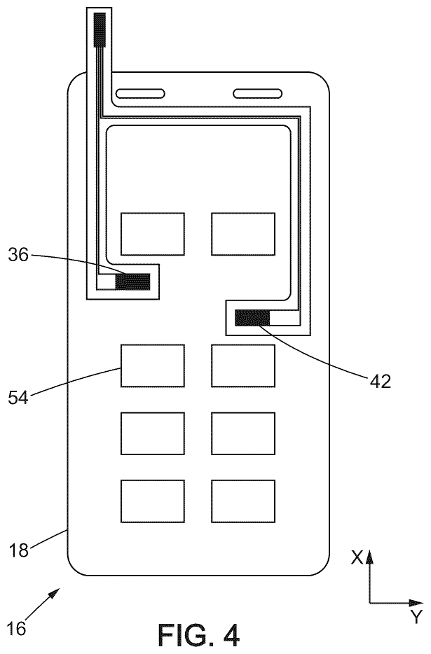

FIG. 4 shows a first variant of the seat element according to the first embodiment. According to this first variant, the seat element comprises only the first capacitive sensor 36 and the second capacitive sensor 42. The first capacitive sensor 36 is separated from the second capacitive sensor 42 in a longitudinal direction X by the first distance D1. In the embodiment shown by way of example in FIG. 4, the first capacitive sensor 36 and the second capacitive sensor 42 are located in an upper part of the back rest. Alternatively, the first capacitive sensor and the second capacitive sensor are located in a lower part of the back rest. They are then located at the positions of the third capacitive sensor 38 and the fourth capacitive sensor 40.

Alternatively, the removable cushion is configured to cover both the front face 8 of the back rest and the squab face 5 of the seat squab, and the capacitive sensors are arranged only on the part of the cushion configured to rest against the seat back rest.

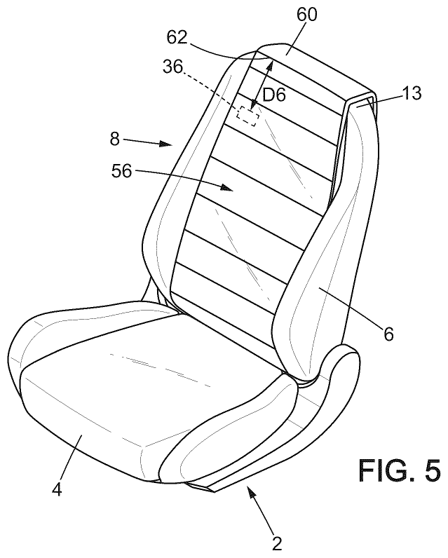

FIG. 5 shows a second variant of the seat element according to the first embodiment. According to this first alternative, the seat element is a removable back rest cushion 56 identical or similar to the removable cushion 16 according to the first embodiment, with the exception that the removable cushion has no openings 28 or indentations. It is placed on the upper face 13 of the seat. It is attached to the back rest, for example, with tie cords.

The removable cushion 56 comprises a bearing portion 60 configured to bear against the upper face 13 of the seat. This bearing portion 60 is shaped like a transverse strip of the padding. The bearing portion 60 comprises a front end 62 intended to be arranged between the upper face 13 and the front face 8 of the back rest. In this alternative, the first capacitive sensor 36 is located at a sixth distance D6 of between 200 and 300 millimeters from the front end 62 of the bearing portion 60. Preferably, the sixth distance D6 is 250 millimeters from the front end 62 of the bearing portion 60.

The other technical features of the removable cushion according to this second alternative are identical to the technical features of the removable cushion according to the first embodiment and will not be disclosed again. For simplicity, FIG. 5 shows only the first capacitive sensor, but the removable cushion 56 comprises two, three or four capacitive sensors.

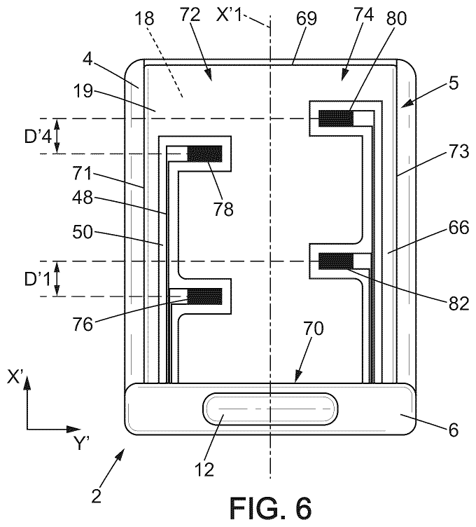

FIG. 6 shows a seat element according to a second embodiment. This seat element is a removable squab cushion 66, that is, the removable cushion is intended to be placed on the squab face 5 of the seat squab. This removable cushion comprises at least one padding 18 and a cover 19 arranged around the padding. The padding 18 comprises a layer of foam or stuffing. The padding may also comprise several layers of foam or stuffing.

The removable squab cushion 66 is defined in relation to a new reference frame (X′, Y′) shown in FIG. 6. The removable squab cushion 66 extends in a longitudinal direction X′ and a transverse direction Y′ perpendicular to the longitudinal direction X′. The removable cushion comprises a front transverse edge 69 and a rear transverse edge 70 extending in the transverse direction Y. The removable cushion 16 further comprises two longitudinal side edges 71, 73 extending in the longitudinal direction X′.

In the same way as for the seat element of the first embodiment, a central longitudinal plane (X′, Z′) is defined, perpendicular to the median plane of the squab cushion. The central longitudinal plane (X′,Z′) is not shown. It intersects the center of the squab cushion 66 along a central straight line X′1. The central straight line X′1 runs parallel to the longitudinal side edges 71, 73. The central straight line X′1 is located in the center, that is, halfway between the two longitudinal side edges 71, 73 of the squab cushion. For the purposes of this description, the “first side 72” of the cushion is the side of the cushion located on one side of the central straight line X′1, for example on the left, and the “second side 74” is the side of the cushion located on the other side of the central straight line X′1, for example on the right.

Preferably, the removable squab cushion 66 comprises a first coplanar interdigital electrode capacitive sensor 76 and a second coplanar interdigital electrode capacitive sensor 82, hereinafter referred to as the first and second capacitive sensors.

The first capacitive sensor and the second capacitive sensor are arranged between the padding 19 and the cover 18. The first capacitive sensor and the second capacitive sensor extend in the transverse direction Y. They are suitable for measuring capacitance values. The first capacitive sensor 76 is arranged on the first side 72 of the removable squab cushion. The second capacitive sensor 82 is arranged on the second side 74 of the central straight line X′1 of the cushion.

The first capacitive sensor 76 is separated from the second capacitive sensor 38 in the longitudinal direction X′ by a first distance D′1. The first distance D′1 is between 30 and 50 millimeters. Preferably, the first distance D′1 is equal to 40 millimeters.

Preferably, the squab cushion 66 comprises a third coplanar interdigital electrode capacitive sensor 78 and a fourth coplanar interdigital electrode capacitive sensor 80 arranged between the cover 19 and a foam layer of the padding or between two foam layers of the padding. The third capacitive sensor 78 is situated on the first side 72 of the central straight line X′1. The fourth capacitive sensor 80 is situated on the second side 74 of the central straight line Z1.

The third capacitive sensor is separated from the fourth capacitive sensor in the longitudinal direction X′ by a fourth distance D4′ of between 30 millimeters and 50 millimeters. Preferably, the fourth distance D4′ is equal to 40 millimeters.

The technical elements of the seat element according to the second embodiment which are identical or similar to the technical elements of the seat element according to the first embodiment bear the same references and will not be disclosed a second time.

Some people may adopt an unsuitable sitting position on a seat or chair such as an office chair, medical chair or vehicle seat. This inappropriate posture can cause back pain.

In particular, drivers may tend to slouch in their seats or bend over due to fatigue or loss of muscle tone during long car journeys. Some drivers twist their spines as they drive with one hand or turn toward their neighbor. These postures are not ergonomic and can cause back pain. Some cars may have a seat with a posture detection function. For cars not equipped with this function, a seat element such as a removable cushion provided with this function can be mounted on the seat.

This seat element should not only be suitable for people of different morphologies, but also for seats of different dimensions. In particular, in the motor vehicle sector, it would be desirable for the removable cushion to be suitable for category A, category B or category C vehicle seats.

A first aim of the present disclosure is to provide a seat element capable of detecting the bad posture of seat occupants with different morphologies and regardless of the size of the seat whereupon it is mounted.

A second aim of the present disclosure is to provide a seat element capable of detecting rotations of the occupant's torso or pelvis. In particular, rotations around a vertical axis.

The object of the present disclosure is a seat element of a seat, in particular of a motor vehicle seat; the seat element comprising a padding and a cover arranged around the padding, the seat element extending in a transverse direction and a longitudinal direction; the seat element comprising two longitudinal side edges; a longitudinal central plane extending between and halfway between the two longitudinal side edges; a first side of the seat element being located on one side of the longitudinal central plane, a second side being located on the other side of the longitudinal central plane; the seat element comprising a first coplanar interdigital electrode capacitive sensor arranged on the first side and a second coplanar interdigital electrode capacitive sensor arranged on the second side; the second capacitive sensor being distant from the first capacitive sensor in a longitudinal direction by a first distance of between 30 millimeters and 50 millimeters, and preferably by a first distance of 40 millimeters.

Advantageously, when the second and third capacitive sensors are separated by this first distance, the capacitance values they generate enable body torsion positions to be detected, whatever the size of the seat and the morphology of the occupant.

The features disclosed in the following paragraphs may optionally be implemented. They can be implemented independently of one another or in combination with one another:
The seat element comprises a removable back rest cushion intended to be placed on a seat, the seat comprising a squab and a back rest articulated to the squab, the back rest having a front face suitable for receiving a back of an occupant, the removable back rest cushion being intended to be placed on the front face of the back rest of the seat.
The first capacitive sensor is spaced apart from the second capacitive sensor by a second distance of between 50 millimeters and 150 millimeters, preferably by a second distance of 80 millimeters, this second distance being measured in a transverse direction.
It further comprises a third coplanar interdigital electrode capacitive sensor arranged on the first side of the central longitudinal plane, and the third capacitive sensor is distanced from the first capacitive sensor in the longitudinal direction by a third distance of between 250 millimeters and 290 millimeters, and preferably by a third distance equal to 270 millimeters.

Advantageously, when the first and third capacitive sensors are separated by this distance, the capacitance values generated by these sensors can detect rounding of the seat occupant's back around a horizontal axis, whatever the size of the seat and the morphology of the seat occupant.
It further comprises a fourth coplanar interdigital electrode capacitive sensor arranged on the second side of the central longitudinal plane, the fourth capacitive sensor being distanced from the third capacitive sensor in the longitudinal direction by a fourth distance of between 30 millimeters and 50 millimeters, and preferably by a fourth distance equal to 40 millimeters.
The fourth capacitive sensor is spaced apart from the third capacitive sensor by a fifth distance of between 50 millimeters and 150 millimeters, and preferably by a fifth distance of 80 millimeters, the fifth distance being measured in a transverse direction.

The removable seat cushion is intended to be mounted on a seat comprising a headrest and at least one rod attached to the back rest and the headrest, and wherein the seat cushion comprises at least one opening for receiving the at least one headrest attachment rod, the seat cushion having a front edge bordering the opening and extending over the front face of the seat back rest, and the first capacitive sensor is located at a sixth distance from the front edge; the sixth distance being between 200 and 300 millimeters, and preferably the sixth distance being equal to 250 millimeters.

Advantageously, this positioning of the first capacitive sensor makes it possible to detect a more pronounced movement or pressure of the shoulder blade of a seat occupant.
The removable seat cushion is intended to be mounted on the back rest comprising an upper face, and wherein the removable seat cushion comprises a bearing portion intended to bear against the upper face of the back rest, the bearing portion comprising a front end intended to be arranged between the upper face and the front face of the back rest, and wherein the first capacitive sensor is located at a sixth distance from the front end of the bearing portion, the sixth distance being between 200 and 220 millimeters, and preferably the sixth distance being equal to 210 millimeters.
The seat element comprises a removable seat squab cushion intended to be placed on a seat, the seat comprising a squab and a back rest articulated to the squab, the squab having a squab face suitable for receiving an occupant, the removable squab cushion being intended to be placed on the squab face of the squab of the seat.
The seat element comprises a third coplanar interdigital electrode capacitive sensor arranged on the first side and a fourth coplanar interdigital electrode capacitive sensor arranged on the second side, the third capacitive sensor being separated from the fourth capacitive sensor in a longitudinal direction by a fourth distance of between 30 millimeters and 50 millimeters and, preferably, by a fourth distance D4′ equal to 40 millimeters.

The present disclosure also relates to a seat, in particular a motor vehicle seat, the seat comprising a squab and a back rest articulated to the squab, the back rest having a front face, a rear face and an upper face, the seat comprising a seat element having at least one of the above-mentioned characteristics, and the first capacitive sensor is located at a sixth distance of between 200 and 300 millimeters, and preferably at a sixth distance of 250 millimeters from the edge located between the upper face and the front face, when the seat element is attached to the seat.

The present disclosure relates to a seat element (16) comprising a padding (18) and a cover arranged around the padding, the seat element comprising two longitudinal side edges (24, 26), a first side (32) of the seat element being located on one side of a longitudinal central plane, a second side (34) being located on the other side of the longitudinal central plane, the seat element comprising a first coplanar interdigital electrode capacitive sensor (36) arranged on the first side (32) and a second coplanar interdigital electrode capacitive sensor (42) arranged on the second side (34, the second capacitive sensor (42) being distant from the first capacitive sensor (36) in a longitudinal direction (X) by a first distance (D1) of between 30 millimeters and 50 millimeters.

1. A seat element of a motor vehicle seat, the seat element comprising
a padding and
a cover arranged around the padding, the seat element extending in a transverse direction and a longitudinal direction, the seat element comprising two longitudinal side edges, a longitudinal central plane extending between and halfway between the two longitudinal side edges, a first side of the seat element being located on one side of the longitudinal central plane, a second side being located on the other side of the longitudinal central plane,
wherein in that the seat element comprises a first coplanar interdigital electrode capacitive sensor arranged on the first side and a second coplanar interdigital electrode capacitive sensor arranged on the second side, the second capacitive sensor being distant from the first capacitive sensor in a longitudinal direction by a first distance of between 30 millimeters and 50 millimeters.

2. The seat element of claim 1, wherein the seat element comprises a removable back rest cushion intended to be placed on a seat, the seat comprising a squab and a back rest articulated to the squab, the back rest having a front face suitable for receiving a back of an occupant, the removable back rest cushion being intended to be placed on the front face of the back rest of the seat.

3. The seat element of claim 2, wherein the first capacitive sensor is spaced apart from the second capacitive sensor by a second distance of between 50 millimeters and 150 millimeters, this second distance being measured in a transverse direction.

4. The seat element of claim 2, further comprising a third coplanar interdigital electrode capacitive sensor arranged on the first side of the central longitudinal plane, and wherein the third capacitive sensor is distanced from the first capacitive sensor in the longitudinal direction by a third distance of between 250 millimeters and 290 millimeters.

5. The seat element of claim 2, further comprising a fourth coplanar interdigital electrode capacitive sensor arranged on the second side of the central longitudinal plane, the fourth capacitive sensor being distanced from the third capacitive sensor in the longitudinal direction by a fourth distance of between 30 millimeters and 50 millimeters.

6. The seat element of claim 5, wherein further comprising a third coplanar interdigital electrode capacitive sensor arranged on the first side of the central longitudinal plane, and wherein the third capacitive sensor is distanced from the first capacitive sensor in the longitudinal direction by a third distance of between 250 millimeters and 290 millimeters, and wherein the fourth capacitive sensor is spaced apart from the third capacitive sensor by a fifth distance of between 50 millimeters and 150 millimeters, the fifth distance being measured in a transverse direction.

7. The seat element of claim 2, wherein the removable seat cushion is intended to be mounted on a seat comprising a headrest and at least one rod attached to the back rest and the headrest, and wherein the seat cushion comprises at least one opening for receiving the at least one headrest attachment rod, the seat cushion having a front edge bordering the opening and extending over the front face of the seat back rest, and wherein the first capacitive sensor is located at a sixth distance from the front edge, the sixth distance being between 200 and 300 millimeters.

8. The seat element of claim 2, wherein the removable seat cushion is intended to be mounted on the back rest comprising an upper face, and wherein the removable seat cushion comprises a bearing portion intended to bear against the upper face of the back rest, the bearing portion comprising a front end intended to be arranged between the upper face and the front face of the back rest, and wherein the first capacitive sensor is located at a sixth distance from the front end of the bearing portion, the sixth distance being between 200 and 220 millimeters.

9. The seat element of claim 1, wherein the seat element comprises a removable seat squab cushion intended to be placed on a seat, the seat comprising a squab and a back rest articulated to the squab, the squab having a squab face suitable for receiving an occupant, the removable squab cushion being intended to be placed on the squab face of the squab of the seat.

10. The seat element of claim 9, wherein the seat element comprises a third coplanar interdigital electrode capacitive sensor arranged on the first side and a fourth coplanar interdigital electrode capacitive sensor arranged on the second side, the third capacitive sensor being separated from the fourth capacitive sensor in a longitudinal direction by a fourth distance of between 30 millimeters and 50 millimeters.

11. The seat element of claim 1, wherein the first distance is equal to 40 millimeters.

12. The seat element of claim 3, wherein the second distance is equal to 80 millimeters.

13. The seat element of claim 4, wherein the third distance is equal to 270 millimeters.

14. The seat element of claim 5, wherein the fourth distance is equal to 40 millimeters.

15. The seat element of claim 6, wherein the third distance is equal to 270 millimeters and wherein the fifth distance is equal to 80 millimeters.

16. The seat element of claim 7, wherein the sixth distance is equal to 250 millimeters.

17. The seat element of claim 8, wherein the sixth distance is equal to 210 millimeters.

18. The seat element of claim 10, wherein the fourth distance is equal to 40 millimeters.

19. A motor vehicle seat comprising a squab and a back rest articulated to the squab, the back rest having a front face, a rear face and an upper face; the seat comprising the seat element according to claim 2, and wherein the first capacitive sensor is located at a sixth distance of between 200 and 300 millimeters, from the edge located between the upper face and the front face, when the seat element is attached to the seat.
